(19) United States
(12) Patent Application Publication
(10) Pub. No.: US 2010/0030812 A1
(43) Pub. Date: Feb. 4, 2010

(54) Method for inserting a contact

(75) Inventor: Thomas Reichhart, Aldenhoven (DE)

Correspondence Address: Friendrich Von Rohrscheidt, 7400 Whitepine Road, Richmond, VA, 23237, US

(73) Assignee: HIFLEX SOFTWARE GESMBH, Wien (AT)

(21) Appl. No.: 12/587,292

(22) Filed: Oct. 5, 2009

(30) Foreign Application Priority Data
Apr. 5, 2007 (DE) DE 102007016933.9
Apr. 3, 2008 (EP) PCT/EP2008/002656

(51) Int. Cl. G06F 17/30

(52) U.S. Cl. 707/104.1; 707/E17.01

(57) ABSTRACT

The invention relates to a method for inserting a contact, which is defined in a procurement system, into an individual list of contacts for a buyer in the procurement system. In order to insert the contact of a supplier known to a buyer into the list of the buyer automatically, it is proposed that the procurement system reads out an identification feature from an address and inserts the contact into the list, when the buyer accesses the address, which contains the identification feature of the contact, and logs into the procurement system.

### RELATED APPLICATIONS

This application claims priority from and incorporates by reference German patent application serial No. DE 10 2007 016933.9, filed on Apr. 5, 2007 and International patent application serial No. PCT/EP2008/002656, filed on Apr. 3, 2008.

### BACKGROUND

1. Field of the Invention

The invention relates to a method for inserting a contact, which is defined in a procurement system, into an individual list of contacts of a buyer in the procurement system.

2. Introduction

Procurement systems, so called e-procurement systems are well known and facilitate the procurement of products and services in many different ways in particular through the internet. A well known open system, thus without particular hardware requirements designed for the use with standard browsers is e.g. implemented in the web portal Hiflex Print Support (www.printsupport.com) of the applicant.

In the known procurement system, both the supplier and the buyer of print- and media products log in at least with their respective contact information. After the log in, the buyer can define a request for the issuance of a quote for a print- or media product assisted by the procurement system and can send it through the procurement system to different providers.

The buyer typically restricts the list of suppliers, to whom he sends his request, based on various criteria. In particular an individual list of potential suppliers is stored in the procurement system for every buyer. The buyer can add suppliers to this list, which are registered in the procurement system themselves, as well as suppliers, which are not registered in the procurement system.

In addition to the suppliers in this list, the procurement system provides the buyer, if desired, with a choice of additional suppliers registered in the procurement system, specifically for the respective defined request for the submission of quote. The buyer can add these additional suppliers to his individual list as well.

The known procurement system offers a substantial simplification of business operations from the submission of a quote, through the issuing of an order to its fulfillment, not only for the buyer, but also for the supplier of print- and media products, which is among others due to the possibility of networking in particular with JDF-based Management Information Systems (MIS). Suppliers registered in the known procurement system therefore wish that the buyers of as many of their customers as possible register in the procurement system as well and use it for their purchases.

In the known procurement system, the buyer solicited by a supplier has to insert the contact information of the supplier into his list of contacts in the procurement system in a comparatively complex manner in order to be able to use the contact information. In particular for buyers with large volumes, who switch to the known procurement system with extensive lists of suppliers of their own, this process is fraught with the uncertainty for the supplier, if the buyer inserts his contact or not. Therefore, actively advertising the known procurement system to buyers is not necessarily successful for the supplier.

3. Object of the Invention

It is the object of the invention to insert a contact of a supplier known to the buyer into the list of the buyer automatically.

### BRIEF SUMMARY OF THE INVENTION

Based on the known method, it is proposed according to the invention, that the procurement system reads out an identification feature from an address and inserts the contact into the list, when the buyer accesses the address, which contains the identification feature of the contact, and logs into the procurement system.

The method according to the invention makes it simple for a buyer, which has been successfully solicited by a supplier and is logged into the procurement system, to insert the contact of this supplier into his individual list of suppliers. Except for accessing a particular address of the procurement system, no further activity of the buyer specifically directed to the integration of the contact is required for inserting the contact of the supplier. The identification feature, which is included in the address, is in particular an alphanumeric identifier, e.g. a consecutively issued supplier number, a real name of the supplier or also a combination of both.

In a method according to the invention the supplier associated with the contact preferably provides the address to the buyer in the form of a Universal Resource Identifier (URI). According to RFC 1630 a URI is a string of characters, which identifies an abstract or physical resource. Thus, a Uniform Resource Locator (URL) identifies a resource in a network for an access by means of a known protocol, e.g. FTP or HTTP. The supplier can transmit such an address to the buyer in particular standardized by email or provide it on a webpage as an internet link for access with a browser. Thus, in the view of the buyer, accessing the address remains the only activity being specifically directed to integrating the contact of the supplier, which is reduced to a single mouse click and thus substantially simplified.

In the method according to the invention, the identification feature is particularly preferably integrated into the address as a parameter. In particular in a HTTP-URL, e.g. for a supplier “Müller” with the supplier number 0815 the identification feature can be handed over in the form www.printsupport.com/ad?vendor=0815 as a parameter for a CGI-script to be executed in the procurement system. Alternatively the address itself can be individualized also by means of the parameter, e.g. as a reference to a subpage in the form “www.printsupport.com/mueller”. Furthermore, the identification feature can also be integrated in coded form as a parameter in order to avoid a directly visible reference to the function.

In a method according to the invention the procurement system advantageously initially saves the identification feature into a file on a local workstation of the buyer, when the address is accessed, and only fetches the file from the workstation after login, reads the identification feature from the file after transmission of the file through the workstation, and inserts the contact into the list. Such a method according to the invention avoids losing the identification feature, even when the (potential) buyer does not log into the procurement system immediately after accessing the address. Even when the buyer accesses the non individualized “main address” of the procurement system (e.g. www.printsupport.com) subsequently, registers as a new user in the procurement system and logs in, the procurement system can inquire at the workstation, if the file exists, request its content and insert the complete contact into the individual list of the buyer based on the identification feature. The procurement system can store the identification feature for this purpose in particular in a profile file, a so called “cookie”, in the workstation of the buyer in a generally known manner.

Alternatively, when the buyer is already logged into the procurement system, the procurement system can read out the identification feature directly when the address is accessed and can insert the associated contact into the list of the buyer.

### DETAILED DESCRIPTION OF THE INVENTION

The invention will be described subsequently with reference to an embodiment. A printing company “Müller” is registered with its contact information in the procurement system as one of a plurality of suppliers of print- and media products under the consecutively issued supplier number 0815, in particular with its mailing address, name, telephone (land line, mobile telephone and internet telephone), facsimile, telex, and email of the contact persons for different product categories. In the footer of each outgoing email and at a prominent location on his own website the supplier refers to the procurement system under the third-level domain “mueller.printsupport.com” and explicitly asks his customers to process requests for quotation through this procurement system and to compare his services with the services of other suppliers.

The procurement system is installed as software on an essentially commercial computer. The user interface of the procurement system can be accessed by potential buyers through the internet worldwide by means of its URL through a network interface, using standard internet browsers on standard PCs as a client. Print jobs with all technical specifications for the production of a printed product can be defined by means of the user interface of the procurement system.

The procurement system can be connected through the same network interface or through an additional network interface through the internet with different systems of suppliers registered in a supplier database of the procurement system e.g. for transmitting print jobs to the respective supplier. In particular the procurement system comprises a control module, by means of which control information for a print job can be generated for a Management Information System (MIS) of a supplier. The procurement system initiates the automatic execution of the print job through the MIS in a connected networked graphic production by transmitting the control information to the MIS.

A buyer for a long term customer, with whom the supplier has agreed upon a 5% volume discount at an annual order volume of over ∈10,000, issues his purchase orders via facsimile so far. As requested in the email from the supplier, the buyer accesses the address recited supra of the procurement system through a standard internet browser on his workstation. At this address, he is automatically relayed by the procurement system under www.printsupport.com/ad?vendor=mueller to a CGI script, which saves the content “mueller” in the cookie archive of the workstation for each connection with a host in the domain “printsupport.com” under the name “vendor”. The script furthermore dynamically generates a login page individualized with the information of the supplier for the internet portal for procuring any type of print- and media products, in which login page the buyer is welcomed by the supplier as a potential future user of the portal. Starting on this login page, the buyer initially obtains detailed information regarding the procurement system, and plans to test the offered services with one of his next orders.

A few days later, the buyer receives a rush order for a trade show brochure with a paper format, which, as he remembers from a prior request, the supplier Müller cannot deliver. After a facsimile inquiry at another a prior supplier, the buyer registers under www.printsupport.com in the procurement system and logs in directly with his new user name and his selected password. Subsequently, he defines the same request for his print job in the procurement system again and opens his individual list of contacts. By opening the list, a contact list module of the procurement system inquires at his workstation, if a cookie with the name “vendor” is defined for the domain “printsupport.com”, receives the content “mueller” of the cookie as a return value and associates the supplier Müller with said return value and inserts the contact information for the supplier Mueller into the list of the buyer after confirmation from the buyer.

At the same time, the procurement system marks Müller as a potential supplier for the defined job in the list of the buyer, since the supplier Müller can meanwhile deliver the requested paper format. During the further execution in the procurement system, the buyer receives an email reply from the other supplier previously solicited via facsimile, which also refers to the procurement system in its footer portion. The surprised buyer accesses the procurement system again through this second individualized internet link. The procurement system in turn relays to the CGI script, which, since the buyer is already registered and also currently logged into the system, only generates an inquiry, if this additional new supplier shall also be inserted into the list, and executes this insertion after confirmation by the buyer.

A selection module of the procurement system searches the individual list of contacts of the buyer based on the specifications of the print job and displays the potential suppliers for the print job to the buyer in a list in the browser. The buyer only selects the print shop “Müller” from this list for a respective inquiry, since he had already inquired at the second supplier via facsimile.

A request module of the procurement system generates a request for issuing a quotation for the print job of the buyer and transmits this request directly through the internet to the MIS at “Müller”. The supplier's MIS automatically generates a quotation based on the specification of the print job within a few seconds and transmits the quotation through the internet back to the procurement system. The procurement system generates a report on the user interface of the buyer that a quotation is provided for him and sends the quotation to the buyer by email simultaneously.

The buyer selects the link, which is stored in the message and included in the email and which refers to an ordering module of the procurement system, examines the specifications of the quotation of the supplier “Müller” shown therein, and issues the print job to the supplier through a mouse click on the respective button.

A job order module of the procurement system generates the job order with reference to the quotation, and in turn transmits the job order directly to the MIS at “Müller”. The MIS automatically generates an order confirmation and transmits it back to the procurement system. The MIS furthermore initiates the production with the specifications of the print job on the executing systems of the connected networked graphic production and relays status reports from the executing systems to the procurement system.

When an order confirmation is received, the procurement system generates a message on the user interface of the buyer stating that a confirmation for his order is provided. The buyer selects the link, which is stored in the message and which refers to a status module of the procurement system, in which the status report is already provided in historic sequence, showing the receipt of order confirmed, production initialized, plate exposed and the future status reports with the respective projected points in time up to the delivery of the print job to the buyer.

What is claimed is:

1. A method for inserting a contact, which is defined in a procurement system, into an individual list of contacts for a buyer in the procurement system, wherein the procurement system reads out an identification feature from an address and inserts the contact into the list, when the buyer accesses the address, which contains the identification feature of the contact, and logs into the procurement system.

2. A method according to claim 1, wherein the address is provided to the buyer in the form of a URI by a supplier with whom the contact is associated.

3. A method according to claim 1, wherein the identification feature is integrated into the address as a parameter.

4. A method according to claim 2, wherein the identification feature is integrated into the address as a parameter.

5. A method according to claim 1, wherein the procurement system initially saves the identification feature into a file on a local workstation of the buyer, when the address is accessed, and only fetches the file from the workstation after login, reads the identification feature from the file after transmission of the file through the workstation, and inserts the contact into the list.

6. A method according to claim 2, wherein the procurement system initially saves the identification feature into a file on a local workstation of the buyer, when the address is accessed, and only fetches the file from the workstation after login, reads the identification feature from the file after transmission of the file through the workstation, and inserts the contact into the list.

7. A method according to claim 3, wherein the procurement system initially saves the identification feature into a file on a local workstation of the buyer, when the address is accessed, and only fetches the file from the workstation after login, reads the identification feature from the file after transmission of the file through the workstation, and inserts the contact into the list.

8. A method according to claim 4, wherein the procurement system initially saves the identification feature into a file on a local workstation of the buyer, when the address is accessed, and only fetches the file from the workstation after login, reads the identification feature from the file after transmission of the file through the workstation, and inserts the contact into the list.
